(19) United States
(12) Patent Application Publication
(10) Pub. No.: US 2012/0225703 A1
(43) Pub. Date: Sep. 6, 2012

(54) METHOD FOR PLAYING A VIDEO GAME ON A MOBILE DEVICE

(75) Inventors: Chen-Wei SU, Taipei City (TW); Chun-Ping Fang, Taipei City (TW)

(73) Assignee: AIBELIVE CO., LTD, Taipei City (TW)

(21) Appl. No.: 13/471,821

(22) Filed: May 15, 2012

Related U.S. Application Data
(63) Continuation-in-part of application No. 12/926,015, filed on Oct. 21, 2010.

(51) Int. Cl. A63F 13/06

(52) U.S. Cl. 463/2; 463/31; 463/7; 463/9; 463/8

(57) ABSTRACT

A method for playing a video game on a mobile device by starting up the mobile device for enabling the mobile device to select a predetermined game program and to execute the selected game program so that the user can give an instruction to the mobile device by hand gesture, voice or touch control, controlling the processor of the mobile device to run the boosted game program and to display the video on a display screen of the mobile device after a recognition step by comparing the inputted signal with multiple 3D space hand gesture signal data in a database of the mobile device by the processor.

This application is a Continuation-In-Part of application Ser. No. 12/926,015, filed on Oct. 21, 2010, now pending. The patent application identified above is incorporated here by reference in its entirety to provide continuity of disclosure.

### BACKGROUND OF THE INVENTION

1. Field of the Invention

The present invention relates to video game technology and more particularly, to a method for playing a video game on a mobile device by means of inputting instructions into the mobile device by hand gesture, voice or touch control for controlling the processor of the mobile device to run a game program wirelessly, wherein the mobile device has stored in a database thereof multiple 3D space hand gesture signal data for the matching of every input signal to improve input accuracy.

2. Description of the Related Art

Following the step of the development of technology and electronic industry, many advanced electronic and electrical products have been created, and have appeared on the market. Beside electric and electronic home appliances, computer is one of the most popularly used advanced products. In addition to word processing and computing functions, computer is practical for playing electronic games and on-line games. Further, many different interactive entertainment computers or game consoles are created for use with a display device, television or monitor for playing video games. A computer-based or game console-based game system may use a keyboard, mouse, joystick or remote controller for operation control. However, the limited function of keyboard, mouse, joystick or remote controller cannot satisfy different game operation requirements. Nowadays, many different game grips have been created for controlling a computer or game console to play a video game. By means of operating a game grip to transmit a control signal to the computer or game console, the user can control the running of a game program in the computer or game console. When operating the game grip, a corresponding control signal is synchronously transmitted to the computer or game console, controlling the running of the game program in the computer or game console synchronously. In actual practice, this game grip control method still has drawbacks as follows:
1. The simple operating functions of conventional game grips cannot satisfy the need for running different game programs. For running a different game program, a different game grip, such as swing type game grip, joystick type game grip, steering wheel type game grip, game grip for flying control or game grip for shooting control, may be necessary. It is expensive to buy many different types of game grips. Further, storing many different types of game grips requires much storage space.
2. Except the function of transmitting the signal of an action in a wireless manner, conventional game grips are not practical for creating and transmitting a voice control signal or touch control signal. In consequence, the application of conventional game grips is limited.
3. When operating a conventional game grip, the game grip keeps transmitting the signal of the motion of the user. Any motion of the user will cause the game grip to transmit a signal to the computer or game console. However, the computer or game console does not perform any recognition step upon receipt of a control signal from the game grip. False signal or signal of an incomplete motion may be produced to interfere with the play of the video game. In order to improve the accuracy of the game control, extra game control devices may be necessary, increasing the cost.

Therefore, it is desirable to provide a measure for controlling a mobile device to play a video game that eliminates the drawbacks of the aforesaid conventional designs.

### SUMMARY OF THE INVENTION

The present invention has been accomplished under the circumstances in view. It is one object of the present invention to provide a method for playing a video game on a mobile device, which enables different transient instructions given by the user by means of hand gestures, voice or touch control to be converted into corresponding control signals for controlling running of a predetermined program built in a database of the mobile device after through a signal recognition step.

To achieve this and other objects of the present invention, a method for playing a video game on a mobile device is performed by starting up the mobile device and operating the mobile device to select the game program to be executed. By means of the control module, microphone or input unit of the mobile device, the user can input instructions into the mobile device by hand gesture, voice or touch, enabling the inputted instructions to be converted into corresponding control signals by the control module. When a hand gesture control signal (the action of a hand gesture made in a 3D space (x, y, z-axis) within a predetermined time interval is received, it is compared with multiple 3D space hand gesture signal data in the database of the mobile device for recognition. If the received control signal is not matched, the processor compares the next control signal for recognition. When a match is obtained, the processor of the mobile device controls the execution of the corresponding action of the content of the game program, and drives the display screen to display the mode under execution. After the end of the execution of the game program, the operation is ended.

Further, the control module uses a sensor to detect hand gesture control signal (the action of a hand gesture made in a 3D space (x, y, z-axis) within a predetermined time interval. Further, the mobile device has installed therein a microphone for voice input, a speaker/buzzer for voice output, and an input unit for touch control signal input.

Further, the hand gesture instruction (the motion in a 3D space within a predetermined time interval) inputted into the mobile device must be a complete hand gesture. The mobile device converts each inputted hand gesture instruction, voice instruction or touch-control instruction into a respective control signal for comparison with the multiple 3D space hand gesture signal data in the database by the processor. When matched, the action of the content of the game program is performed subject to the control signal received. When not matched, the false control signal is rejected, minimizing processor operating load and avoiding errors.

Further, by means of the wireless transmission module of the mobile device, the processor of the mobile device can be linked to a television having a wireless video receiver, or to a television without wireless video receiver, via an external wireless video transmitter/receiver, so that the user can operate the mobile device to play a video game on the television comfortably, avoiding tired eyes or vision problems.

### BRIEF DESCRIPTION OF THE DRAWINGS

FIG. 1 is a system block diagram of a mobile device in accordance with the present invention.

FIG. 2 is an operation flow chart of the present invention (I).

FIG. 3 is an operation flow chart of the present invention (II).

FIG. 4 is a diagram of a 3D dynamic data flow obtained through the sensor of the control module of the mobile device in accordance with the present invention (I).

FIG. 5 is a diagram of a 3D dynamic data flow obtained through the sensor of the control module of the mobile device in accordance with the present invention (II).

FIG. 6 is a system block diagram illustrating an application example of the present invention.

FIG. 7 is a system block diagram illustrating another application example of the present invention.

### DETAILED DESCRIPTION OF THE PREFERRED EMBODIMENT

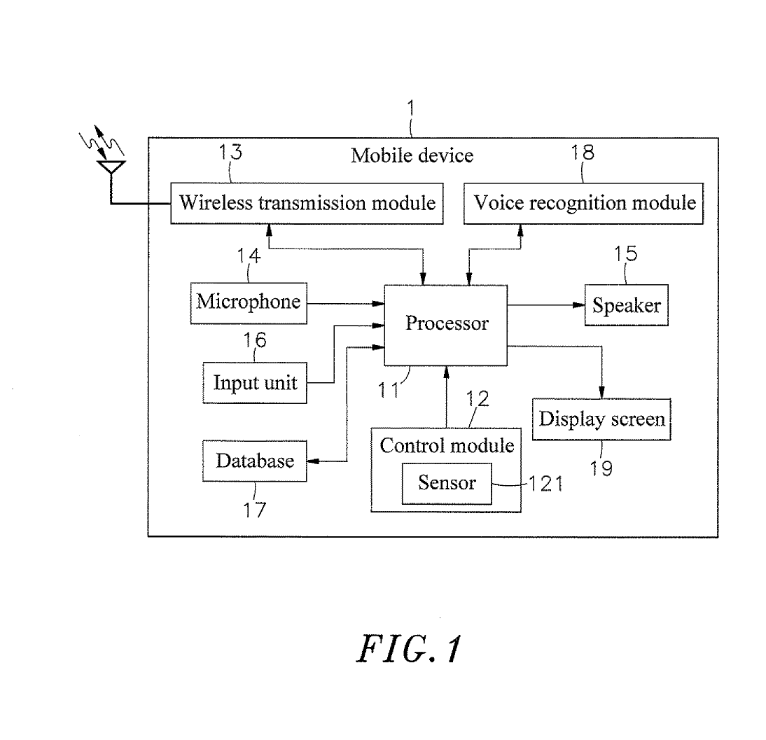

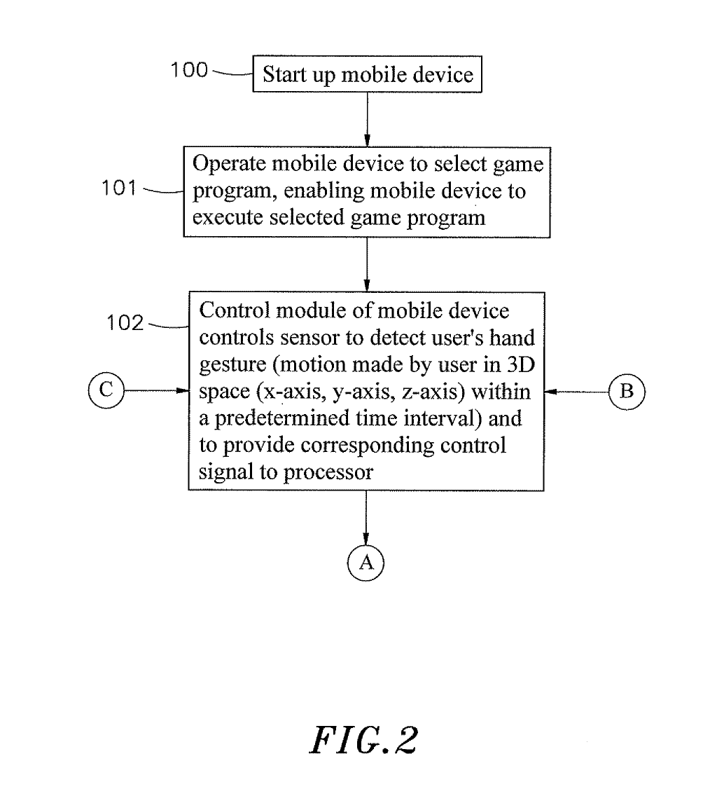

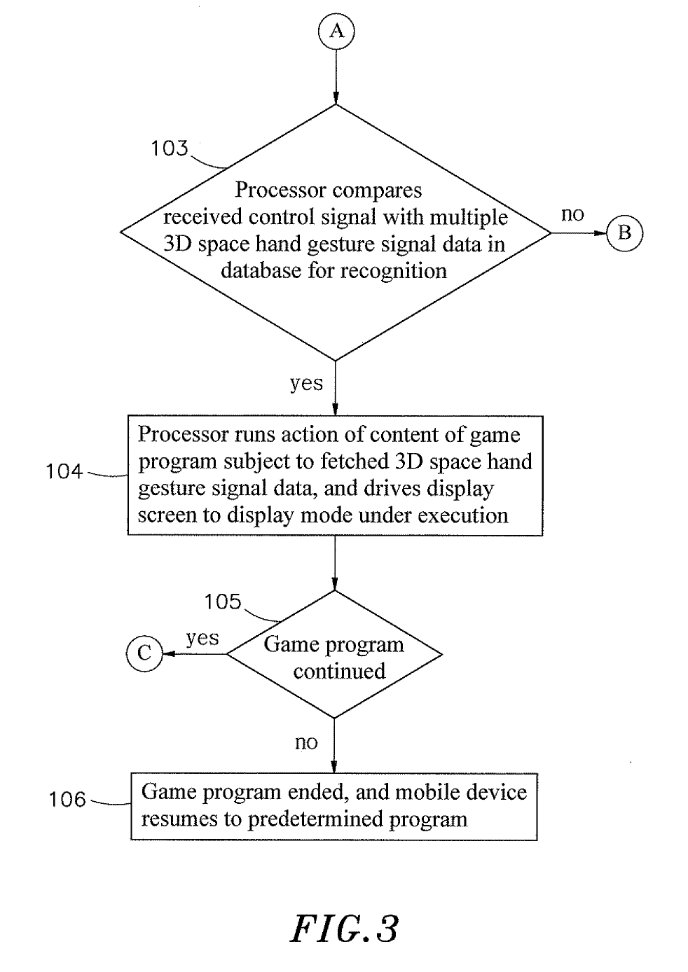

Referring to FIGS. 1-5, the invention is adapted to play a video game on a mobile device 1.

The mobile device 1 comprises a processor 11, a control module 12, a wireless transmission module 13, a microphone 14, a speaker (or buzzer) 15, an input unit 16, a database 17, a voice recognition module 18, and a display screen 19. Further, the control module 12 includes a sensor 121. Further, the database 17 has stored therein multiple 3D space hand gesture signal data (X, Y, Z 3-axis data), such as the signal of the motion of a first blow in a 3D space, the signal of a swing motion in a 3Dspace, the signal of a push motion in a 3D space, the signal of a circle round motion in a 3D space, the signal of the motion of sliding action in a 3D space, the signal of a jump in a 3D space, or any of a variety of data input signals, including the signal of a clicking action to input an instruction, the signal of a touch control action to input an instruction, the signal of an action in a 3D space inputted by voice, and etc.

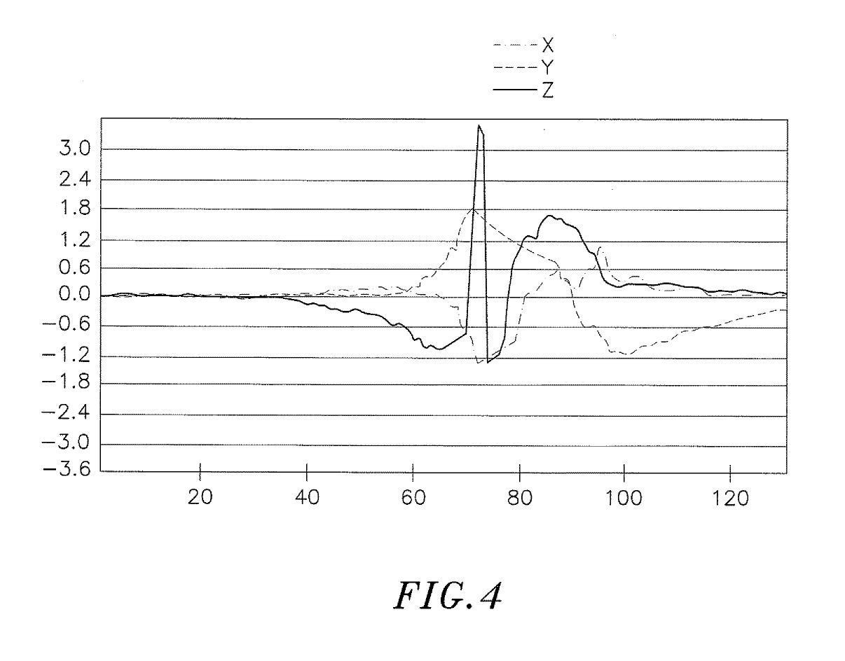

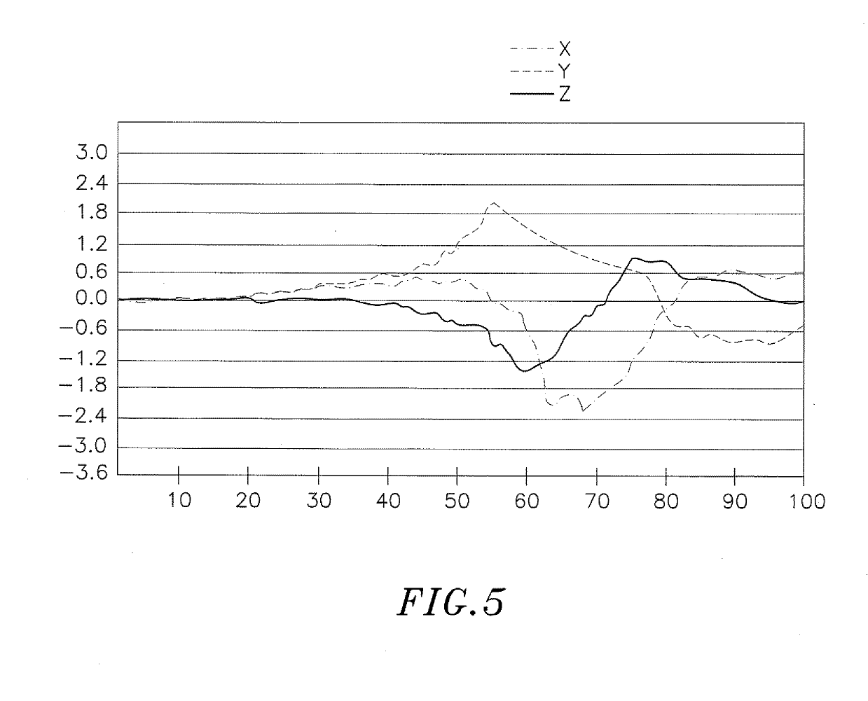

The processor 11 of the mobile device 1 can be a CPU, chip or microprocessor that is capable of carrying out the instructions of a computer program and performing the basic arithmetical, logical, and input/output operations of the mobile device 1. The mobile device 1 can be a cell phone, PDA, game grip, joystick or remote controller for signal input. Further, the sensor 121 of the control module 12 can be a G-sensor, acceleration sensor or gyro sensor, or a combination of an acceleration sensor and a gyro sensor that is capable of sensing the signal of a hand gesture in a 3D space within a time interval (for example, 1 second, 2 seconds or 3 seconds), for example, the 3-axis signal of the motion of a first blow, swing, push, circle round, slide or jump in a 3D space. In FIGS. 4 and 5, the vertical axis (y-axis) is a variation curve of motion in a 3D space; the transverse axis (x-axis) is the 100 data produced within one unit time (voice signal or touch input signal, such as, signal of clicking action or signal of touch control action).

The control module 12, microphone 14 and input unit 16 of the mobile device 1 are adapted for the input of motion signals, voice signals, or touch control signals. Thus, the mobile device 1 provides multiple application modes for inputting instructions without through any other control devices. Further, the input unit 16 can be a keyboard, joystick or touch panel. The display screen 19 can be a LCD screen, plasma screen, LED screen or touch screen for A/V signal output. Further, in the case that the display screen 19 is a touch screen, the input unit 16 is eliminated, and the touch screen provides all the functions of the input unit 16.

The predetermined game program stored in the mobile device 1 can be an intelligence game program, real-time strategy game program, role-playing game program, or sports game program. The intelligence game can be Chinese chess game, Go game, Gobang game, or jumping chess game. The sports game can be boxing game, tennis game, baseball game, basketball game, volleyball game, sumo game, rowing game, archery game, racing game, running game, treasure hunter game, high jump game, or broad jump game.

The method for playing a video game on the mobile device 1 includes the steps of:
(100) Start up the mobile device 1.
(101) Operate the mobile device 1 to select the game program to be executed, enabling the mobile device 1 to execute the selected game program.
(102) The control module 12 of the mobile device 1 controls the sensor 121 to detect the user's hand gesture (the motion made by the user in a 3D space (x-axis, y-axis, z-axis) within a predetermined time interval) and to provide a corresponding control signal to the processor 11. (
103) The processor 11 compares the received control signal with the multiple 3D space hand gesture signal data in the database 17 for recognition, and then proceeds to step (104) when matched, or returns to step (102) when not matched.
(104) The processor 11 runs the action of the content of the game program subject to the fetched 3D space hand gesture signal data, and drives the display screen 19 to display the mode under execution.
(105) The processor 11 determines whether or not the game program is to be continued? And then returns to step (102) when positive, or proceeds to step (106) when negative.
(106) The game program is ended, and the mobile device 1 resumes to a predetermined operating program.

As stated above, the mobile device 1 converts the hand gesture the user made within a predetermined time interval, such as, the motion of first blow, arrow propelling, shooting displacement, horse riding, boat rowing, jumping, running or walking in a 3D space (x-axis, y-axis, z-axis), the voice instruction (for the action of first blowing, circling round, swinging, throwing, hitting or jumping) inputted by the user through the microphone 14, or the instruction inputted through the input unit 16 (touch panel, touch switches, handwriting system) into a control signal, and then transmits such a control signal to the processor 11. Upon receipt of the control signal, the processor 11 compares the received control signal with the multiple 3D space hand gesture signal data in the database 17. When a match is obtained, the processor 21 executes the corresponding action of the content of the game program subject to the control signal, and drives the display screen 19 to display video. Thus, every operating function of the game program is executed.

The hand gesture instruction (the motion in a 3D space within a predetermined time interval) inputted into the mobile device 1 must be a complete hand gesture, for example, fist-blowing outward to a certain position, circling round through one turn or a number of turns, swinging to a certain position. Voice instructions (for the motion of first blowing, circling round, swinging, throwing, hitting or jumping) can be inputted by the user through the microphone 14 into the mobile device 1, or touch-control instructions can be inputted through the input unit 16 (touch panel, touch switches, handwriting system) into the mobile device 1. The mobile device 1 converts each inputted hand gesture instruction, voice instruction or touch-control instruction into a respective control signal that is compared to the multiple 3D space hand gesture signal data in the database 17 by the processor 11 for recognition. When matched, the action of the content of the game program is performed subject to the control signal received. When not matched, the false control signal is deleted, avoiding interference with the running of the predetermined program.

It is to be understood that the aforesaid embodiment is simply an example of the present invention but not intended for use as a limitation. According to the method for playing a video game on a mobile device in accordance with the present invention, an instruction can be given to the mobile device 1 through the control module 12, the microphone 14 or the input unit 16 by hand gesture, voice or touch. The inputted instruction is converted into a control signal for comparison with the multiple 3D space hand gesture signal data in the database 22 by the processor 11 so that the processor 11 can execute the corresponding action of the content of the game program. Thus, the user can operate the mobile device 1 by hand gesture, voice or touch control to control the running of a predetermined program in the mobile device 1 accurately, minimizing processor operating load and avoiding errors.

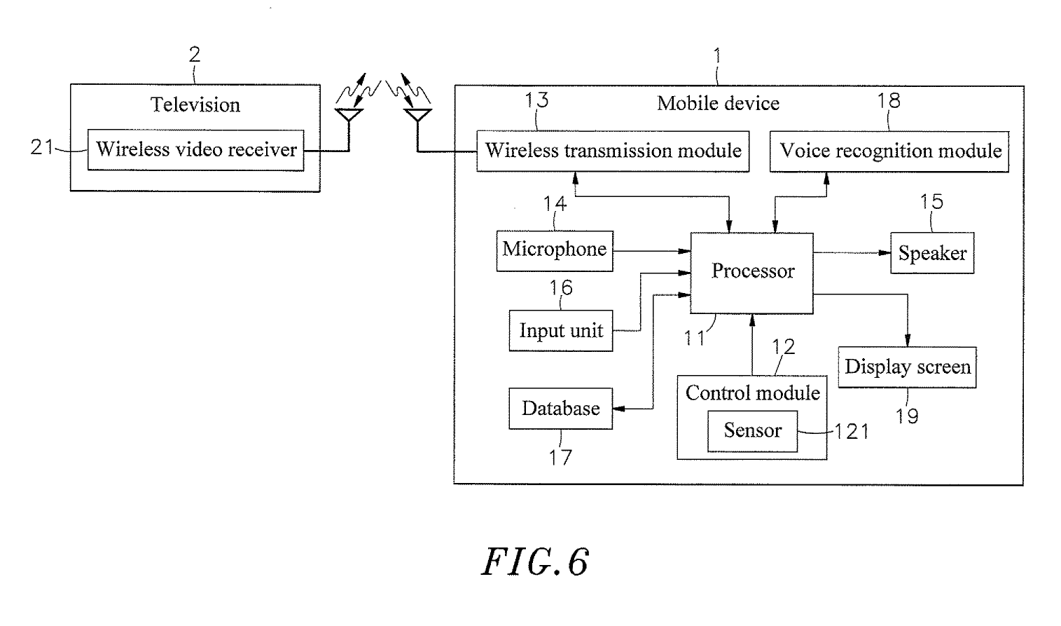

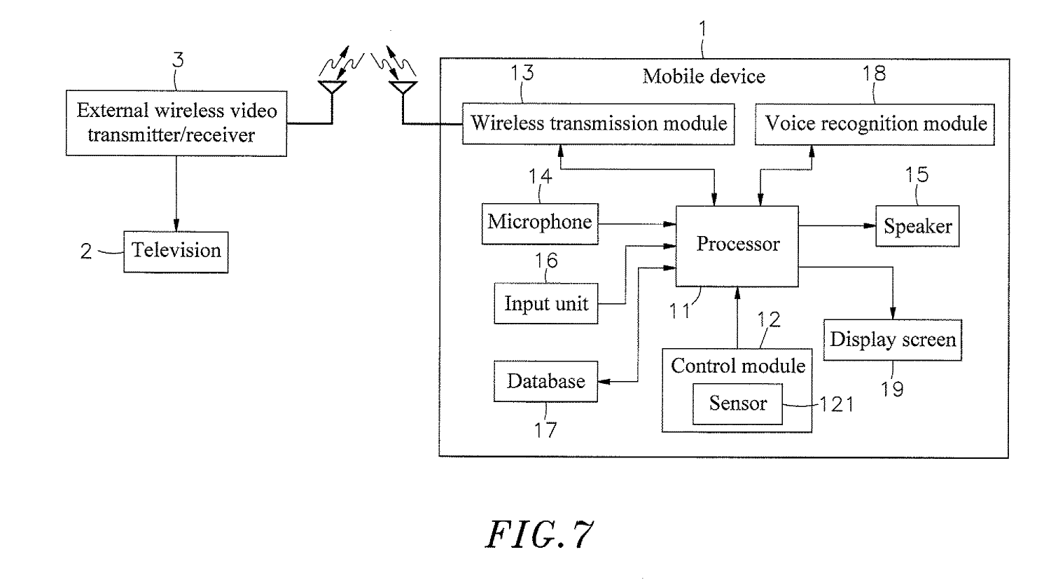

Referring to FIGS. 6 and 7 and FIGS. 1-3 again, by means of the wireless transmission module 13, the processor 11 of the mobile device 1 can be linked to a television 2 that is equipped with a wireless video receiver 21 (see FIG. 6). Alternatively, an external wireless video transmitter/receiver 3 can be connected to the television 2 by a connection interface (HDMI, AVI or DVI standards), enabling the processor 11 of the mobile device 1 to be linked to a television 2 through the external wireless video transmitter/receiver 3. Thus, the user can operate the mobile device 1 to play a video game on the television 2 comfortably, avoiding tired eyes or vision problems.

In conclusion, the invention provides a method for operating a mobile device to control a main unit in playing a video game that has the advantages and features as follows:

1. The mobile device 1 has built therein a control module 12, a microphone 14, an input unit 16, a database 17, a voice recognition module 18 and a display screen 19 for inputting instructions by hand gesture, voice or touch without through any other control devices, and the processor 11 of the mobile device 1 can compare every control signal generated by the control module 12 with the multiple 3D space hand gesture signal data in the database 17 and then run the matched content of the game program, and therefore the mobile device 1 provides multiple application modes, the user can save much control device cost and control device installation and storage space.

2. By means of using the control module 12 for inputting 3D space hand gesture instructions, the microphone 14 for inputting voice instructions and the input unit 16 for inputting touch-control instructions, the mobile device 1 provides multiple input functions, facilitating application.

3. When a motion or displacement is sensed, the processor 11 of the mobile device 1 compares the respective control signal with the multiple 3D space hand gesture signal data in the database 17. Any incomplete or false hand gesture instruction will not be in match with the multiple 3D space hand gesture signal data in the database 17, and will be rejected. After input of a complete or correct hand gesture instruction, the instruction is converted into a corresponding control signal and transmitted to the processor 11 for comparing with the multiple 3D space hand gesture signal data in the database 2217, and the corresponding action of the content of the game program will be executed only when a match is obtained, avoiding errors.

4. By means of the wireless transmission module 13, the processor 11 of the mobile device 1 can be linked to a television 2 having a wireless video receiver 21, or to a television 2 without wireless video receiver via an external wireless video transmitter/receiver 3, so that the user can operate the mobile device 1 to play a video game on the television 2 comfortably, avoiding tired eyes or vision problems.

Therefore, the scope of the invention is the design of signal transmission in a mobile. After input of a complete hand gesture instruction in a 3D space (x, y, z-axis) within a predetermined time interval, the hand gesture instruction for comparing with multiple 3D space hand gesture signal data stored in a database by the processor of the mobile device. When a match is obtained, a corresponding action of the content of a predetermined game program boosted in the mobile device is executed. Further, the mobile device has built therein a control module for inputting hand gesture instructions, a microphone for inputting voice instructions and an input unit for inputting touch-control instructions. Thus, the mobile device provides multiple input functions, facilitating application.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A method for playing a video game on a mobile device, said mobile device comprising a processor, a control module, a database having stored therein multiple 3D space hand gesture signal data (X, Y, Z, 3-axis data), a voice recognition module and a display screen, the method comprising the steps of:
(A01) starting up said mobile device;
(A02) operating said mobile device to select a predetermined game program and to execute the selected game program;
(A03) enabling said control module of said mobile device to control a sensor thereof in detecting the user's hand gesture (the motion made by the user in a 3D space (x-axis, y-axis, z-axis) within a predetermined time interval) and to provide a corresponding control signal to said processor;
(A04) enabling said processor to compare the received control signal with the multiple 3D space hand gesture signal data in said database for recognition; and
(A05) enabling said processor to execute the action of the content of the game program subject to the fetched 3D space hand gesture signal data, and to drive said display screen to display the mode under execution.

2. The method as claimed in claim 1, further comprising the step of, after step (A05), enabling said processor to determine whether or not the game program is to be continued, and then to return to step (A03) when positive, or to end the game program and to resume to a predetermined operating program when negative.

3. The method as claimed in claim 1, said predetermined game program is selected from the group of intelligence game programs, real-time strategy game programs, role-playing game programs, and sports game programs.

4. The method as claimed in claim 1, said mobile device is a mobile telephone, PDA, game grip, joystick or remote controller.

5. The method as claimed in claim 1, wherein said mobile device further comprises a microphone for voice input, a joystick, a speaker/buzzer for voice output, and an input unit for touch control signal input.

6. The method as claimed in claim 1, wherein said sensor of said sensor of said control module of said mobile device is selected from the group of gravity sensor, acceleration sensor and gyro sensor.

7. The method as claimed in claim 1, wherein said hand gesture instruction according to step (A03) is the motion made by the user in a 3D space (x-axis, y-axis, z-axis) within a predetermined time interval (for example, 1, 2 or 3 seconds), a voice signal or a touch-control input signal.

8. The method as claimed in claim 7, wherein the motion made by the user in a 3D space (x-axis, y-axis, z-axis) within a predetermined time interval is a first blow action, swinging action, pushing action, circling round action, sliding action or jumping action.

9. The method as claimed in claim 7, wherein the touch-control input signal is a signal of a clicking action input signal or touch control action input signal.

10. The method as claimed in claim 1, wherein the multiple 3D space hand gesture signal data in said database according to step (A04) includes the signal of the motion of a first blow in a 3D space, the signal of the motion of a swinging action in a 3D space, the signal of the motion of a pushing action in a 3D space, the signal of the motion of a circling round action in a 3D space, the signal of the motion of a sliding action in a 3D space, the signal of the motion of a jumping action in a 3D space, the signal of a clicking action to input an instruction, the signal of a touch control action to input an instruction and the signal of an action in a 3D space inputted by voice.

11. The method as claimed in claim 1, further comprising the step of, after step (A05), enabling said processor to transmit game images to a wireless video receiver of a television through a wireless transmission module of said mobile device for display on a display screen of said television.

12. The method as claimed in claim 1, further comprising the step of, after step (A05), enabling said processor to transmit game images through a wireless transmission module of said mobile device to an external television via an external wireless video transmitter/receiver for display on a display screen of said television.
